(19) United States
(12) Patent Application Publication
(10) Pub. No.: US 2025/0378354 A1
(43) Pub. Date: Dec. 11, 2025

(54) SYSTEMS, APPARATUSES, METHODS, AND NON-TRANSITORY COMPUTER-READABLE STORAGE MEDIA FOR FOUNDATION MODEL WITH EFFICIENT KNOWLEDGE GRAPH RETRIEVAL SYSTEM FOR CITATION-BASED QUESTION ANSWERING

(71) Applicant: HUAWEI TECHNOLOGIES CO., LTD., Shenzhen (CN)

(72) Inventors: Mohammad Ali Alomrani, Kanata (CA); Mohammad Dehghan, Whitby (CA); Yingxue Zhang, Markham (CA); Boxing CHEN, Ottawa (CA); Mahdi Biparva, Toronto (CA); Mehdi Rezagholizadeh, Vaughan (CA)

(21) Appl. No.: 18/966,404

(22) Filed: Dec. 3, 2024

Related U.S. Application Data
(60) Provisional application No. 63/656,260, filed on Jun. 5, 2024.

(51) Int. Cl. G06N 5/022; G06N 5/04

(52) U.S. Cl. CPC G06N 5/022; G06N 5/04

(57) ABSTRACT

A computerized method for generating an answer to an input question, the method has the steps of: identifying, in a knowledge graph (KG), one or more entities included in the input question; finding, in the KG, a plurality of reasoning paths for the one or more entities based on comparison of a similarity between an embedding of each of the plurality of reasoning paths and an embedding of the input question; retrieving a plurality of quotes from a network, each quote being a piece of text related to the input question taken verbatim from the network; and sending the input question, and an input set to a foundation model (FM) to obtain the answer, the input set comprising the plurality of reasoning paths and the plurality of quotes.

### CROSS-REFERENCE TO RELATED APPLICATION

This application claims the benefit of U.S. Provisional Patent Application Ser. No. 63/656,260, filed Jun. 5, 2024, the content of which is incorporated herein by reference in its entirety.

### FIELD OF THE DISCLOSURE

The present disclosure relates generally to systems, apparatuses, methods, and computer-readable storage media for large language model, and in particular to systems, apparatuses, methods, and computer-readable storage media for large language model with efficient knowledge graph retrieval system for citation-based question answering.

### BACKGROUND

Foundation models (FMs) or language models (LMs) such as large language models (LLMs) are neural network models that learn the semantics and syntax of language by encoding (sub) words into vector representations. FMs have been used in various artificial intelligence (AI) applications such as generic question-answering (QA) systems. However, existing LLMs for generic QA systems have several disadvantages such as high computational cost and slow user experiences.

### SUMMARY

The citation-based question-answering (QA) systems have improved not only the factual correctness but also the ease of verification of the generative AI's answer. However, the reliance of such systems on homogeneous web-text hinders the ability of the systems to stay comprehensive that could also exacerbate the turn-around time. An Enhanced Web and Efficient Knowledge graph (KG) retrieval solution (EWEK-QA) to enrich the content of the extracted knowledge fed to the system is described herein. EWEK-QA is equipped with an adaptive web retriever, and modules to utilize KG triples in an efficient manner. EWEK-QA's adaptive web-retriever improves over the heuristic based splitter that is conventionally used, and the KG-retrieval enables augmenting knowledge from graphs.

According to one aspect, embodiments of this disclosure provide a method of enriching the content of extracted knowledge using an enhanced web and knowledge graph retrieval for citation-based question in an artificial intelligence system.

According to one aspect of this disclosure, there is provided a computerized method for generating an answer to an input question, the method comprising: identifying, in a knowledge graph (KG), one or more entities included in the input question; finding, in the KG, a plurality of reasoning paths for the one or more entities based on comparison of a similarity between an embedding of each of the plurality of reasoning paths and an embedding of the input question; retrieving a plurality of quotes from a network, each quote being a piece of text related to the input question taken verbatim from the network; and sending the input question, and an input set to a foundation model (FM) to obtain the answer, the input set comprising the plurality of reasoning paths and the plurality of quotes.

In some embodiments, said finding the plurality of reasoning paths comprises: finding, in the KG, the plurality of reasoning paths for the one or more entities using a beam search method based on the comparison of the similarity between the embedding of each of the plurality of reasoning paths and the embedding of the input question.

In some embodiments, said finding the plurality of reasoning paths for the one or more entities using the beam search method comprises: using each of the one or more entities as a source node in the beam search method.

In some embodiments, the plurality of reasoning paths is a path set having T reasoning paths, where T is a predefined or predetermined positive integer.

In some embodiments, said finding the plurality of reasoning paths for the one or more entities using the beam search method comprises: for each of the one or more entities, iteratively expanding a reasoning path from a current leaf node by including neighboring entities of the current leaf node, obtaining a scalar score for the reasoning path based on the comparison of the similarity between the embedding of the reasoning path and the embedding of the input question, and updating the path set by comparing the scalar score of the reasoning path with scalar scores of the reasoning paths in the path set.

In some embodiments, each of the plurality of reason paths has a maximum depth D, where D is a predefined or predetermined positive integer.

In some embodiments, the method further comprises: encoding the plurality of reason paths to a plurality of KG triples in text form.

In some embodiments, the answer is in text form and comprises a plurality of citations each indicating an item in the input set.

In another aspect, embodiments of this disclosure provide an apparatus, wherein the apparatus comprises a function or unit to perform any of the methods disclosed herein.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a system comprising a node for performing the above-described method.

According to one aspect of this disclosure, there is provided an apparatus for implementing the method in any possible implementation of the foregoing aspects.

The computerized method disclosed herein various advantageous effects such as:
no extensive LLM finetuning needed,
compatible with any KG out-of-the-box,
better performance across all knowledge graph question answering (KGQA) and open-domain question answering (ODQA) question types (for example, factual, non-factual, multi-hop, and/or the like),
no expensive LLM calls during retrieval,
adaptive to incomplete KGs as it explores multiple paths at once,
removing effect of LLM hallucinations on retrieval.
better interpretability,
ability to cite fine-grained knowledge in KGs and the web, and
better user experience for search engine applications.

The methods and solutions disclosed herein may be suitable for any applications of QA systems such as generative search engines. An example of a concrete use case may be a QA system for a social network. As those skilled in the art will appreciate, social networks can be modeled as KGs where the nodes represent users while the edges represent interactions (for example, tweets, likes, and/or the like). Using EWEK-QA, users can get personalized intelligent responses for any search queries on the network.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM); and

FIGS. 5A to 5C are schematic diagrams showing different types of the LLMs shown in FIG. 4, wherein

FIG. 5A is a schematic diagram showing an encoder-based LLM,

FIG. 5B is a schematic diagram showing a decoder-based LLM, and

FIG. 5C is a schematic diagram showing an encoder-decoder-based LLM;

FIG. 6 is a schematic diagram showing the AI engine shown in FIG. 4 which comprises two retrieval modules (KG retrieval and web retrieval) that work in parallel; according to some embodiments of this disclosure.

### DETAILED DESCRIPTION

Embodiments disclosed herein relate to artificial intelligence (AI) systems and apparatuses using foundation models (FMs) or language models (LMs) such as large language models (LLMs). The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

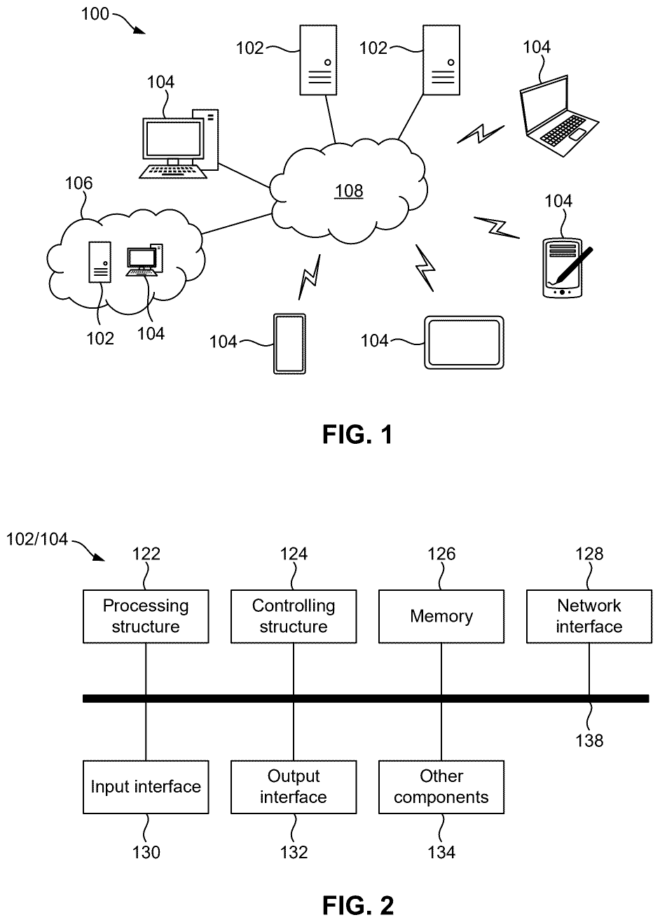

Turning now to FIG. 1, an exemplary computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

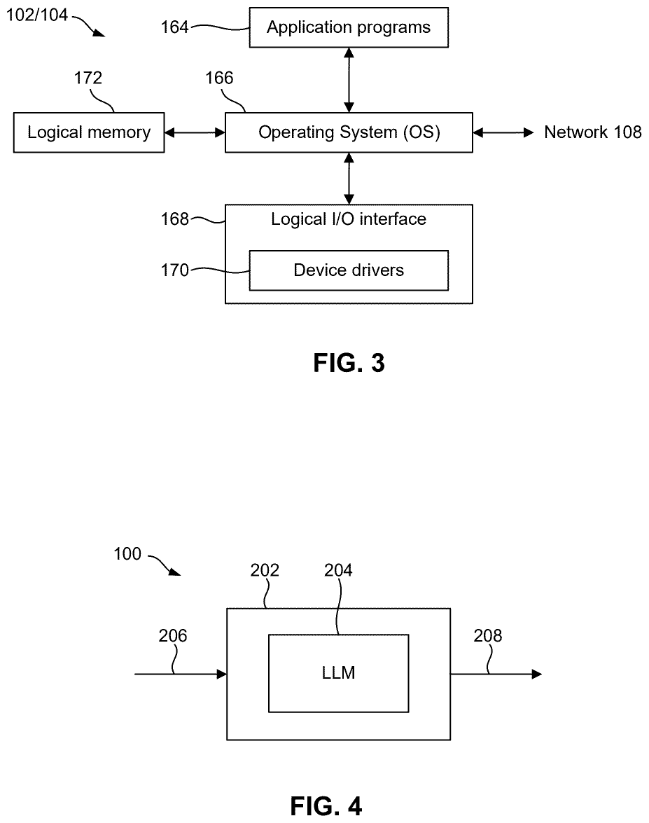

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Large Language Model

In some embodiments, the computer network system 100 executes an artificial intelligence (AI) engine (for example, in the form of one or more software programs). As shown in FIG. 4, the AI engine 202 comprises a FM such as a LLM 204 (which is used as an example in the following description) for processing input 206 (also called “prompt”; for example, natural language input in the form of text, image, voice, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub) words into vector representations.

Using LLMs as an example, LLMs use transformer models and are trained using massive datasets. Current LLMs such as ChatGPT (a generative artificial intelligence chatbot developed by OpenAI of San Francisco, California, USA), GPT-4 (Generative Pre-trained Transformer 4, which is a multimodal large language model created by OpenAI of San Francisco, California, USA), LLAMA (a family of autoregressive large language models released by Meta AI of Astor Place, New York City, New York, USA), and PaLM2 (a transformer-based large language model developed by Google AI of Mountain View, California, USA) have proven to achieve state-of-the-art (SOTA) performance in various natural language processing (NLP) tasks.

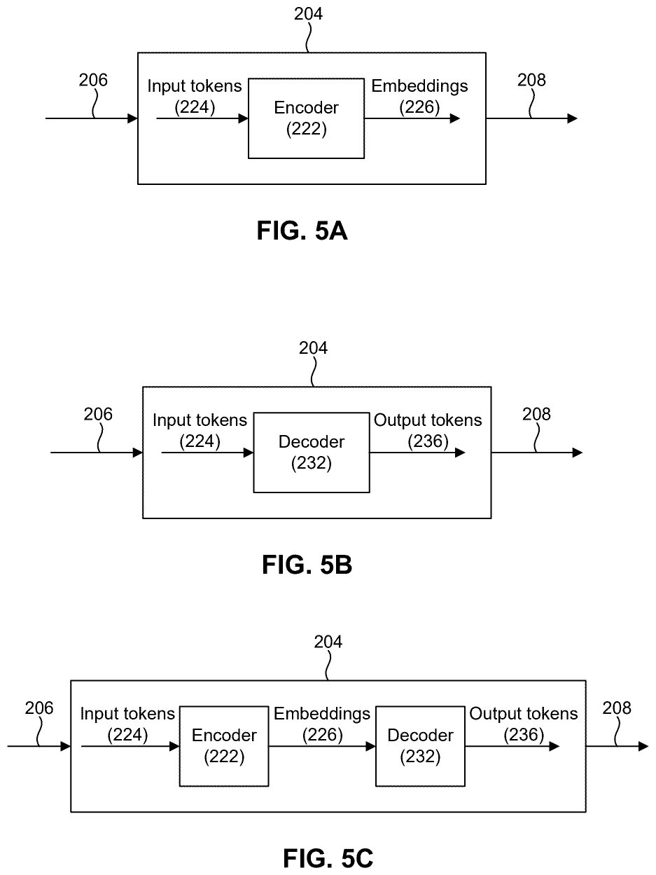

FIGS. 5A to 5C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 5A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 5B, the LLM 204 may be a LLM comprising a decoder 232 which processes the input tokens 224 and generates output tokens 236 (which are then used to generate the output 208). More specifically, the decoder-only LLM 204 learns to produce a distribution for the next token in a sequence given past context as input.

As shown in FIG. 5C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

LLMs have significantly improved the state-of-the-art on various NLP tasks. These models, powered by advanced techniques such as the generative pre-trained transformer (GPT) architecture, can learn the distribution of their training set well enough to generate realistic text.

LLMs may be trained for text generation. That is, given an input sentence (that is, prompt), repeatedly predict the next most probable (sub) word. This is known as auto-regressive language modeling. Thanks to this training objective, LLMs can act as generic question-answering (QA) systems. Specifically, when given a question as well as an instruction (for example, “Answer the following question: Who is the author of the Harry Potter series?”), it can sequentially output words conditioned on the input prompt, which might be an answer, “J. K. Rowling”. The most capable LLMs contain billions of trainable parameters and are based on the decoder-only Transformer architecture. The training corpus typically includes trillions of words compiled from various sources such as the web. LLMs can be adapted for specific tasks either through finetuning (that is, altering internal parameters) or prompt-engineering (that is, altering input prompt). Prompt-engineering does not require any additional model parameter updates (that is, fine-tuning).

Knowledge graphs (KGs) may be used in LLMs. Herein, knowledge graphs (KGs) are general knowledge bases used to represent real-world data in a structured manner. Graphs are comprised of a set of nodes V and edges E. Nodes represent key objects (for example, people) and can have many attributes (for example, age, name, and/or the like). An edge represents a relationship between two nodes (for example, friend).

In KGs, the nodes thereof are referred to as entities, and the edges thereof are sometimes referred to as triples because a KG edge often comprises an object node, relation, and subject node. A pair of nodes can have multiple unique edges. KGs are often used to model complex real-world data (for example, finance) for large-scale systems (for example, search engines, recommendation systems). Examples of KGs include WikiData (see https://www.wikidata.org/) and ConcpetNet (see https://conceptnet.io/). Triples can be retrieved from KGs through simple entity search (that is, finding all triples involving a particular object) or more advanced methods such as SPARQL (see https://www.w3.org/TR/sparql11-query/).

LLMs typically answer prompts using knowledge stored in their internal parameters. Retrieval-augmented generation (RAG) is a technique for enhancing the accuracy and reliability of LLMs by augmenting the prompt with relevant facts. Specifically, an information retrieval component utilizes the prompt to pull information from an external knowledge source (such as a KG). The user prompt and the relevant information are both given to the LLM. The LLM uses the new knowledge and its internal knowledge to create better responses with less hallucinations. Herein, “hallucination” refers to instances where the LLM generates text that is plausibly sounding but factually incorrect, often fabricating facts or details.

The mechanics of information retrieval is dependent on knowledge source. For example, KG retrieval involves entity linking and finding the most relevant neighborhood in the KG. The retrieved triples can then be augmented to the input prompt in textual form (for example, a triple of [John, spouse, Betty]).

Herein, entity linking is the process of identifying and connecting mentions of entities within a text to corresponding entries in the KG. This involves determining which entities in the text map to which nodes in the graph, thus linking the textual data to a structured knowledge base.

Herein, neighborhood of a node refers to its immediate connections within the graph, such as the individuals following a user on a social network.

In QA systems, the objective is to produce an answer y in response to an input question x, with both x and y being sequences of words.

RAG-based QA systems enhance LLMs by incorporating knowledge sourced from an external knowledge base K. Specifically, relevant knowledge R is first retrieved from the knowledge base K based on its relevance to the query x, using a retrieval model, formulated as R=Retrieve (x, K). Subsequently, the retrieved knowledge R is combined with the original query x and provided to the language model as a prompt, which then generates the answer: y=LLM (x, R).

There are two main settings that are often explored in QA systems:
Open-domain question answering: The question can be from any field and can be factual (for example, who invented the light bulb?) or non-factual (for example, how do I make a pie?). This setting often requires a large external and unstructured knowledge source such as Wikipedia.
Knowledge graph question answering: The question is multi-hop (that is, requires several reasoning steps to answer) and is answerable by the facts (triples) in KGs.

In web-based QA, citation-based QA systems can be viewed as an enhanced version of regular RAG solutions. First, they leverage search engines for retrieval which gives them vast amounts of information access. Second, they are able to add citations to relevant retrieved quotes during the answer generation.

For example, WebGPT (a web-based QA system developed by OpenAI of San Francisco, California, USA) fine-tunes an LLM in answering open-ended questions using a text-based web browser. The LLM may be trained to interact with a web browser, issue operation commands (for example, Search, Read, and Quote), retrieve relevant information from websites, and generate an answer with citations. The LLM may be finetuned to mimic human browsing on an annotated dataset of browsing trajectories and answers.

WebGLM (a web-enhanced question-answering system based on the General Language Model (GLM), developed by Tsinghua University, Beijing, China) decomposes QA into three stages. First, the question is entered into the search engine to obtain a list of links for potentially relevant pages. The links are crawled to extract a set of text paragraphs within each web page. Second, an LLM-powered retriever module recalls the top-K most relevant paragraphs (known as quotes) R=[p₁, p₂, . . . , p_{T}] among all websites. Finally, the answer composer (AC) yields an answer according to the question and retrieved paragraphs: y=LLM (x, R). The answer composer is an LLM finetuned for generating an answer with citations to corresponding paragraphs (for example, J.K. Rowling is the author of the Harry Potter series).

In KG-based QA, various technologies have been used in prior art.

For example, given a question, the knowledge-augmented language model prompting (KAPING) technology first identifies the corresponding KG entities e e V via entity linking. The neighborhoods of KG entities are often too large to forward to LLMs. Consequently, KAPING retrieves the most relevant triples incident to e based on their embedding similarity to the question. That is, the method first embeds the question and all triples incident to e onto a vector representation space with off-the-shelf sentence embedding models for text retrieval, and then calculates their similarities. After that, the top-T similar triples to the given question are augmented to the prompt as additional context for the LLM.

The KB-Binder technology employs LLMs to transform questions into SPARQL (a Resource Description Framework (RDF) query language) queries capable of retrieving information from the KG. Upon receiving a question, an LLM initially devises a preliminary query in the form of a draft. However, this initial query may not be immediately executable, as it lacks specific constraints associated with the KG vocabulary, such as node and edge sets. For instance, an entity mentioned in the query might not be present in the KG. Consequently, the potential SPARQL query is refined further using carefully designed entity and relation binders, which establish precise connections with entities and relations existing within the KG.

The reasoning on graphs (RoG) technology prompts a finetuned LLM to generate a relation path p. A relation path is an ordered sequence of relations that can be used to obtain answers to the question. For example, the relation path marry_to→father_of will likely obtain the answer for the question, “Who is the son of Alice's spouse?”. The relation path does not contain the answer but rather constitutes the plan for retrieving the answer from the KG. RoG retrieves a reasoning path p from the KG using the plan. Reasoning paths are the instances of the relation path z in the KG.

For example, Given a relation path: z=[marry_to, father_of], a reasoning path instance could be: p=[Alice, marry_to, Bob, father_of, Charlie], which denotes “Alice” is married to “Bob” and “Bob” is the father of “Charlie”. Finally, RoG the finetuned LLM generates the answer y given the question x and retrieved reasoning paths y=LLM (x, p).

The Think-on-Graph (ToG) technology utilizes an LLM to perform beam search on the KG and retrieve the most relevant reasoning paths p. Herein, beam search is a graph search algorithm that explores a graph by maintaining the top-T most promising paths. At each step, the paths are expanded by exploring the neighbors of the leaf node. Each path is assigned a heuristic cost determining how promising the path is. The least promising paths are pruned and only the top-T promising paths are kept at each step.

ToG constantly updates and maintains top-T reasoning paths for the question x after each iteration, where T denotes the width of beam search. At each step, the LLM expands and scores the paths based on their relevance to the question until it determines that the question can be answered based on the current reasoning paths. The process is performed for a maximum of D steps. Finally, the LLM generates the answer y given the question x and retrieved reasoning paths: y=LLM (x, z).

There are some disadvantages in the prior-art LLM technologies, such as:
Extensive finetuning: Prior-art methods such as RoG require expensive LLM finetuning on the target KGs or QA datasets. This finetuning process is costly for large LLMs.
Extensive LLM prompting: Prior art methods such as ToG and WebGPT call the LLM multiple times before answering the question. LLM prompting can be computationally demanding and too slow for the user experience.
Constrained knowledge source: Prior art methods often use a single knowledge modality (such as text or graphs). This degrades their performance for particular question types. For example, graphs are helpful for multi-hop reasoning questions while the web is useful for non-factual questions.
Expensive LLMs: ToG's performance heavily depends on using LLMs with large parameter count (for example, more than 100 billion (B) parameters) since the LLM is performing reasoning-intensive tasks (that is, KG exploration and pruning). This hinders its deployment on edge devices (for example, smartphones).
Static retrieval: The retrieval and answering/reasoning modules are often loosely coupled. For example, the LLM in KB-Binder plays the role of a static translator which transfers input questions to SPARQL queries for KG searching and reasoning. Consequently, its success heavily depends on the completeness of the knowledge source (that is, KG). The whole process may fail when the LLM outputs an incomplete SPARQL query. Moreover, some methods such as KAPING are often constrained to retrieving one-hop triples only.
Interpretability: KG-based methods do not cite the retrieved knowledge in the generated answer. This makes it difficult to interpret the answer in case of error.

In the following, various embodiments of the AI engine 202 employing an enhanced web and efficient knowledge graph retrieval for citation-based question answering (EWEK-QA) method are described for providing at least some of the following solutions for solving various technical problems:
Citation: The EWEK-QA method cites corresponding references in the KG or the Web.
Combined knowledge sources: The EWEK-QA method can retrieve from both structured (for example, KG) and unstructured (for example, web) knowledge. Additionally, it is readily compatible with any KG.
Prompting-based pipeline: The EWEK-QA method does not require finetuning on any particular dataset, task, or knowledge source. It can use off-the-shelf LLMs with moderate parameter count.
Fast inference: The EWEK-QA method usually requires one (1) to two (2) LLM calls to generate an answer.
Dynamic KG retrieval: The EWEK-QA method searches the KG dynamically and efficiently to retrieve the most relevant reasoning paths.

In various embodiments, the AI engine 202 may use:
parallel knowledge retrieval: Given a question x, the retrieval module retrieves the top-K relevant quotes from the web, and top-T relevant reasoning paths from the KG in parallel. This step is performed without the use of LLMs.
answer composition: A moderate-size LLM composes an answer solely based on the retrieved knowledge, including citations to relevant references.
Beam search KG retrieval: A small encoder neural network performs beam search on the KG to extract the most relevant reasoning paths.

The methods and LLMs disclosed herein may be used in any scenario where QA systems are deployed. For example, generative search engines can use the pipeline disclosed herein to generate trustworthy answers on edge devices (such as smartphones).

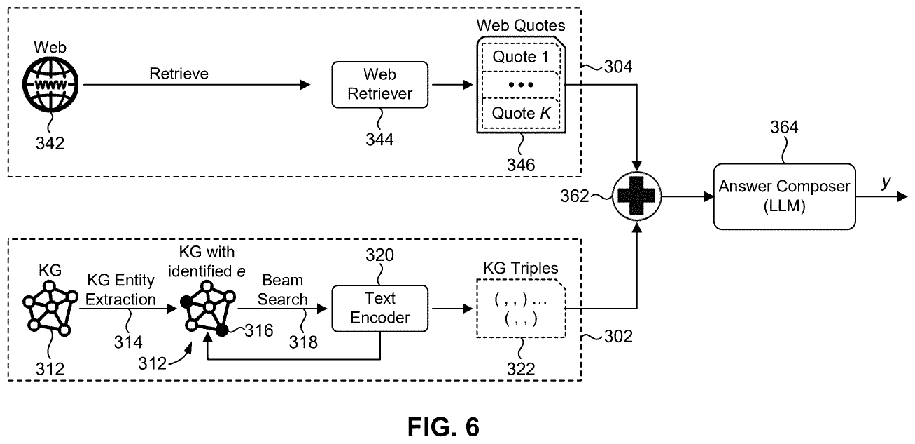

As shown in FIG. 6, in some embodiments, the AI engine 202 comprises two retrieval modules that work in parallel: a KG retrieval module 302 and a web retrieval module 304.

The KG retrieval module 302 comprises an initialization stage 314 (also denoted a “KG entity extraction”), in which, given a question x (also denoted a “prompt”), the entity linking is performed by an LLM 204. That is, the EWEK-QA method prompts the LLM 204 to identify all entities 316 in the question that can be found in the KG 312. We denote these question entities 316 by the set e.

The KG retrieval module 302 also comprises an exploration and pruning (KG beam search) stage 318, which uses beam search to identify the top-T reasoning paths P=[p₁, p₂, . . . , p_{T}] (wherein each of p₁, p₂, . . . , p_{T} represents a respective reasoning path, and Tis a predefined or predetermined positive integer) in the KG 312 for all question entities 316 of the identified question entities e, wherein the identified question entities e are used as the source nodes for these paths. Herein, source and leaf nodes are the first and last nodes in the path respectively.

More specifically, for each identified question entity, the EWEK-QA 202 method starts from the identified question entity as the source node and iteratively refreshes the top-T paths until reaching a maximum depth D. At each iteration, the paths expand by including neighboring entities from the KG 312 based of the current leaf nodes. A scalar score is assigned to each path by measuring its embedding similarity to the question embedding. Lower-scoring paths are pruned, retaining only the top-T new paths.

Consequently, each path p & P consists of D hops. For example, the path [(1, 2), (2, 3)] has D=2 hops from the source node 1 to the leaf node 3.

This iterative process continues for a maximum of D steps. Then, each of the obtained top-T paths is embedded using a text encoder 320 (that is, converting each path to text form). A plurality of KG triples 322 are then obtained It is noteworthy that this process involves no LLM calls.

In the web retrieval module 304, given a question x, the top-K relevant quotes 346, also denoted as Q=[q₁, q₂, . . . q_{K}], are retrieved from the web 342 by using, for example, a web retriever 344. A quote is a piece of text related to the question x that is taken verbatim from the internet by the web retriever 344 via a search engine. The mechanics of this retrieval process is omitted here.

The obtained KG triples 322 (representing the obtained top-T paths for each identified entity) and the top-K retrieved quotes 346 are combined (362), for example, by combining the top-K quotes 346, and the obtained top-T reasoning paths (that is, the KG triples 322 in text form) as an input set R=[q₁, q₂, . . . q_{K}, p₁>p₂, . . . >p_{T}], and sent the input set to an answer composer (AC) 364.

In some embodiments, the AC 364 is an LLM that is instructed for answer composition given the retrieved knowledge. As shown in FIG. 6, the AC 364 uses the question x and the input set R as the input prompt and outputs an answer y=AC(x, R), which is solely based on the retrieved knowledge and not the internal LLM parameters. In some embodiments, the answer y may be in text form, and includes citations at the end of some sentences in the form of “[i]” where i refers to the i-th item (being a reasoning path or quote) in R.

Those skilled in the art will appreciate that the KG 312 generally needs to be a large knowledge graph, and the web retriever 344 generally needs to crawl a large number of locations (such as websites, webpages, and/or the like) of the web 342, in order to ensure the generation of a proper output answer y. Such operations are generally beyond the capacity of human mind, and cannot be performed in human mind (such as using pen and paper). Accordingly, such operations have to be performed using a suitable computer system 100.

The AI engine 202 and EWEK-QA method disclosed herein provide various advantages. For example, in some embodiments, the EWEK-QA method disclosed herein may be used as a prompting-based pipeline, which provides advantages such as no extensive LLM finetuning needed, and compatible with any suitable KG such as any out-of-the-box KG.

As described above, in some embodiments, the AI engine 202 and EWEK-QA method disclosed herein may use combined knowledge sources, thereby providing better performance across all knowledge graph question answering (KGQA) and open-domain question answering (ODQA) question types (for example, factual, non-factual, multi-hop, and/or the like).

As described above, in some embodiments, the AI engine 202 and EWEK-QA method disclosed herein may use dynamic KG retrieval, which uses text encoders, thereby providing various benefits such as no expensive LLM calls during retrieval, adaptive to incomplete KGs as it explores multiple paths at once, and removing effect of LLM hallucinations on retrieval.

As described above, in some embodiments, the AI engine 202 and EWEK-QA method disclosed herein may use citation-based answer composition which provides various advantage such as: better interpretability, ability to cite fine-grained knowledge in KGs and the web, and better user experience for search engine applications.

The methods and solutions disclosed herein, such as the AI engine 202 and EWEK-QA method disclosed herein, may be suitable for any applications of QA systems such as generative search engines. An example of a concrete use case may be a QA system for a social network. As those skilled in the art will appreciate, social networks can be modeled as KGs where the nodes represent users while the edges represent interactions (for example, tweets, likes, and/or the like). Using the AI engine 202 and EWEK-QA method disclosed herein, users can get personalized intelligent responses for any search queries on the network.

In this setting, fast inference and reliability may be important for safe scalability to billions of users. The AI engine 202 and EWEK-QA method disclosed herein helps solve this problem with efficient retrieval and references from multiple knowledge sources.

Although in above examples, the adaptive information retrieval method is performed by the computer network system 100, in some embodiments, no computer network system 100 is required, and the adaptive information retrieval method is performed by a computer 102 or 104.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

1. A computerized method for generating an answer to an input question, the method comprising:
identifying, in a knowledge graph (KG), one or more entities included in the input question;
finding, in the KG, a plurality of reasoning paths for the one or more entities based on comparison of a similarity between an embedding of each of the plurality of reasoning paths and an embedding of the input question;
retrieving a plurality of quotes from a network, each quote being a piece of text related to the input question taken verbatim from the network; and
sending the input question, and an input set to a foundation model (FM) to obtain the answer, the input set comprising the plurality of reasoning paths and the plurality of quotes.

2. The computerized method of claim 1, wherein said finding the plurality of reasoning paths comprises:
finding, in the KG, the plurality of reasoning paths for the one or more entities using a beam search method with each of the one or more entities as a source node and based on the comparison of the similarity between the embedding of each of the plurality of reasoning paths and the embedding of the input question.

3. The computerized method of claim 2, wherein the plurality of reasoning paths is a path set having T reasoning paths, where T is a predefined or predetermined positive integer; and
wherein each of the plurality of reason paths has a maximum depth D, where D is a predefined or predetermined positive integer.

4. The computerized method of claim 3, wherein said finding the plurality of reasoning paths for the one or more entities using the beam search method comprises: for each of the one or more entities,
iteratively expanding a reasoning path from a current leaf node by including neighboring entities of the current leaf node,
obtaining a scalar score for the reasoning path based on the comparison of the similarity between the embedding of the reasoning path and the embedding of the input question, and
updating the path set by comparing the scalar score of the reasoning path with scalar scores of the reasoning paths in the path set.

5. The computerized method of claim 1 further comprising:
encoding the plurality of reason paths to a plurality of KG triples in text form.

6. The computerized method of claim 1, wherein the answer is in text form and comprises a plurality of citations each indicating an item in the input set.

7. One or more processors functionally connected to one or more non-transitory, computer-readable storage media comprising computer-executable instructions, wherein the instructions, when executed, cause the one or more processors to perform the method of claim 1.

8. The one or more processors of claim 7, wherein said finding the plurality of reasoning paths comprises:
finding, in the KG, the plurality of reasoning paths for the one or more entities using a beam search method with each of the one or more entities as a source node and based on the comparison of the similarity between the embedding of each of the plurality of reasoning paths and the embedding of the input question.

9. The one or more processors of claim 8, wherein the plurality of reasoning paths is a path set having T reasoning paths, where T is a predefined or predetermined positive integer; and
wherein each of the plurality of reason paths has a maximum depth D, where D is a predefined or predetermined positive integer.

10. The one or more processors of claim 9, wherein said finding the plurality of reasoning paths for the one or more entities using the beam search method comprises: for each of the one or more entities,
iteratively expanding a reasoning path from a current leaf node by including neighboring entities of the current leaf node,
obtaining a scalar score for the reasoning path based on the comparison of the similarity between the embedding of the reasoning path and the embedding of the input question, and
updating the path set by comparing the scalar score of the reasoning path with scalar scores of the reasoning paths in the path set.

11. The one or more processors of claim 7 further comprising:
encoding the plurality of reason paths to a plurality of KG triples in text form.

12. The one or more processors of claim 7, wherein the answer is in text form and comprises a plurality of citations each indicating an item in the input set.

13. One or more processors functionally connected to one or more non-transitory, computer-readable storage media comprising computer-executable instructions, wherein the instructions, when executed, cause the one or more processors to perform the method of claim 1.

14. The one or more processors of claim 13, wherein said finding the plurality of reasoning paths comprises:
finding, in the KG, the plurality of reasoning paths for the one or more entities using a beam search method based on the comparison of the similarity between the embedding of each of the plurality of reasoning paths and the embedding of the input question.

15. The one or more processors of claim 14, wherein said finding the plurality of reasoning paths for the one or more entities using the beam search method comprises:
using each of the one or more entities as a source node in the beam search method.

16. The one or more processors of claim 14, wherein the plurality of reasoning paths is a path set having T reasoning paths, where Tis a predefined or predetermined positive integer.

17. The one or more processors of claim 16, wherein said finding the plurality of reasoning paths for the one or more entities using the beam search method comprises: for each of the one or more entities,
iteratively expanding a reasoning path from a current leaf node by including neighboring entities of the current leaf node,
obtaining a scalar score for the reasoning path based on the comparison of the similarity between the embedding of the reasoning path and the embedding of the input question, and
updating the path set by comparing the scalar score of the reasoning path with scalar scores of the reasoning paths in the path set.

18. The one or more processors of claim 17, wherein each of the plurality of reason paths has a maximum depth D, where D is a predefined or predetermined positive integer.

19. The one or more processors of claim 13 further comprising:
encoding the plurality of reason paths to a plurality of KG triples in text form.

20. The one or more processors of claim 13, wherein the answer is in text form and comprises a plurality of citations each indicating an item in the input set.
